(19) United States
(12) Patent Application Publication
(10) Pub. No.: US 2017/0044400 A1
(43) Pub. Date: Feb. 16, 2017

(54) SUPERHYDROPHOBIC ELASTOMERIC SILICONE COATINGS

(71) Applicant: CSL Silicones Inc., Guelph (CA)

(72) Inventors: Farooq Ahmed, Guelph (CA); Balwantrai Mistry, Guelph (CA); Jocelyn J. Johansen, Cambridge (CA); Faisal Huda, Oakville (CA); Christopher W. McConnery, Kitchener (CA)

(73) Assignee: CSL Silicones Inc., Guelph (CA)

(21) Appl. No.: 15/219,776

(22) Filed: Jul. 26, 2016

Related U.S. Application Data
(60) Provisional application No. 62/203,559, filed on Aug. 11, 2015.

(51) Int. Cl. C09D 183/04; H01B 3/46; B05D 3/00; H01B 19/04; C09D 5/16; C09D 5/08

(52) U.S. Cl. CPC C09D 183/04; C09D 5/1637; C09D 5/08; B05D 3/007; H01B 19/04; H01B 3/46; C08K 9/06

(57) ABSTRACT

The present application discloses a one-part room temperature vulcanizable (RTV) poly(diorganosiloxane) composition for a superhydrophobic elastomeric silicone coating; a method of coating a high voltage insulator using such a composition and a coated high voltage insulator prepared by such a method or using such a composition. The present application also discloses methods of protecting a substrate, of waterproofing a substrate, for reducing drag on a substrate and/or for inhibiting water from pooling on a horizontal or near-horizontal substrate using such a composition.

### CROSS-REFERENCE TO RELATED APPLICATIONS

The present application claims the benefit of priority from co-pending U.S. provisional application No. 62/203,559 filed on Aug. 11, 2015, the contents of which are incorporated herein by reference in their entirety.

### FIELD

The present application relates to superhydrophobic elastomeric silicone coatings. For example, the superhydrophobic elastomeric silicone coatings can be used for coating high voltage insulators and/or for protection of a substrate from environmental effects such as corrosion.

### BACKGROUND

The surface of a lotus leaf is a natural superhydrophobic surface. The high contact angle of water droplets on a lotus leaf is due to its microscopic uniform surface roughness or texture that traps air and prevents or minimizes contact of the water droplet to the surface.

Synthetic hydrophobic or superhydrophobic coatings comprising particles are known. US Patent Application Publication No. 2008/0090010 to Zhang et al. discloses a hydrophobic coating composition comprising nanoparticles or precursors capable of forming nanoparticles that forms a coating having both micro- and nanoscale roughness. US Patent Application Publication No. 2009/0064894 to Baumgart et al. discloses a coating composition comprising hydrophobic particles having an average size of between 7 nm and 4,000 nm. US Patent Application Publication No. 2006/0286305 to Thies et al. discloses hydrophobic coatings comprising organic or inorganic nanoparticles dispersed in a reactive diluent. U.S. Pat. No. 8,216,674 to Simpson et al. discloses a superhydrophobic powder prepared by applying a hydrophobic coating to the surface of diatomaceous earth.

### SUMMARY

The present application discloses superhydrophobic elastomeric silicone coatings which are useful, for example, for high voltage insulators, corrosion protection, anti-graffiti applications, waterproofing, drag reduction e.g. for waterborne vessels and/or to inhibit water from pooling on horizontal and near-horizontal surfaces. The hydrophobicity of the coatings exceeds the visual standard HC 1 (Completely Hydrophobic) of the Swedish Transmission Research Institute (STRI) guide for the classification of hydrophobicity of High Voltage Insulator surfaces. It possesses excellent resistance to weathering and high temperature and also minimizes or eliminates leakage of current caused, for example, by accumulation of pollutants and moisture on the insulator surface.

Accordingly, the present application includes a one-part room temperature vulcanizable (RTV) poly(diorganosiloxane) composition for a superhydrophobic elastomeric silicone coating, the composition comprising:

(a) about 10-60 wt % of a poly(diorganosiloxane) of Formula I:

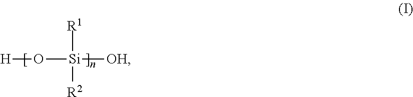

wherein
R¹ and R² are each independently C₁₋₈alkyl, C₂₋₈alkenyl or C₆₋₁₀aryl; and
n has an average value such that the viscosity of the poly(diorganosiloxane) of Formula I is from about 100-100,000 cP at 25° C.;

(b) about 0.5-25 wt % of an amorphous silica reinforcing filler;

(c) about 1-15 wt % of at least one cross-linking agent of Formula II:

(X)₄₋ₘ—Si—R³ₘ (II),

wherein
R³ is C₁₋₈alkyl, C₂₋₈alkenyl or C₆₋₁₀aryl;
m is 0, 1 or 2; and
X is a hydrolysable ketoximino-containing group of Formula III:

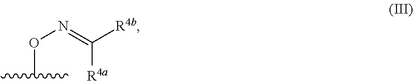

wherein R^{4a} and R^{4b} are each independently C₁₋₈alkyl, C₂₋₈alkenyl or C₆₋₁₀aryl; or
X is a hydrolysable group of Formula IV:

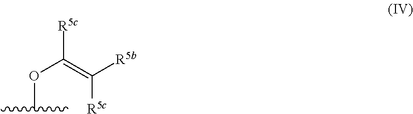

wherein R^{5a}, R^{5b} and R^{5c} are each independently H, C₁₋₈alkyl, C₂₋₈alkenyl or C₆₋₁₀aryl;

(d) about 0.2-5 wt % of an adhesion agent of Formula V:

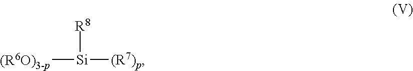

wherein
R⁶ and R⁷ are each independently C₁₋₈alkyl, C₂₋₈alkenyl or C₆₋₁₀aryl;
R⁸ is C₁₋₁₀alkyl, C₂₋₁₀alkenyl, C₁₋₆alklleneNR⁹C₁₋₆alkyleneNR^{10a}R^{10b} or C₆₋₁₀aryl, optionally substituted with one or more organofunctional groups;
R⁹ is H or C₁₋₄alkyl;
R^{10a} and R^{10b} are each independently H or C₁₋₄alkyl; and
p is 0 or 1;

(e) about 0.01-2 wt % of an organometallic condensation catalyst, wherein the metal of the organometallic condensation catalyst is selected from tin, titanium, zirconium, boron, zinc, cobalt and bismuth; and

(f) about 5-35 wt % of an inorganic filler selected from natural diatomaceous earth, calcined diatomaceous earth, zeolite, pumice stone powder and mixtures thereof, dispersed in about 5-40 wt % of an organic solvent,

wherein each alkyl, alkylene, alkenyl and aryl group in the compounds of Formula I, II, III, IV and V is optionally halo-substituted.

The present application also includes a method of coating a high voltage insulator with a superhydrophobic elastomeric silicone coating, the method comprising:

coating a high voltage insulator with a one-part room temperature vulcanizable (RTV) poly(diorganosiloxane) composition of the present application; and

allowing the composition to cure under conditions to obtain the superhydrophobic elastomeric silicone coating.

The present application also includes a method of protecting a substrate, the method comprising:

coating the substrate with a one-part room temperature vulcanizable (RTV) poly(diorganosiloxane) composition of the present application; and

allowing the composition to cure under conditions to obtain a superhydrophobic elastomeric silicone coating.

The present application also includes a method of waterproofing a substrate, for reducing drag on a substrate and/or for inhibiting water from pooling on a horizontal or near-horizontal substrate, the method comprising:

coating the substrate with a one-part room temperature vulcanizable (RTV) poly(diorganosiloxane) composition of the present application; and

allowing the composition to cure under conditions to obtain a superhydrophobic elastomeric silicone coating.

The present application also includes a method of protecting a substrate, of waterproofing a substrate, for reducing drag on a substrate and/or for inhibiting water from pooling on a horizontal or near-horizontal substrate, the method comprising:

coating the substrate with a one-part room temperature vulcanizable (RTV) poly(diorganosiloxane) composition of the present application; and

allowing the composition to cure under conditions to obtain a superhydrophobic elastomeric silicone coating.

In some embodiments wherein the method is for reducing drag on a substrate, the substrate comprises a waterborne vessel.

The present application further includes a coated high voltage insulator comprising a superhydrophobic elastomeric silicone coating obtained according to a method of coating a high voltage insulator of the present application and a coated high voltage insulator comprising a superhydrophobic elastomeric silicone coating prepared from a one-part room temperature vulcanizable (RTV) poly(diorganosiloxane) composition of the present application.

Other features and advantages of the present application will become apparent from the following detailed description. It should be understood, however, that the detailed description and the specific examples, while indicating embodiments of the application, are given by way of illustration only and the scope of the claims should not be limited by these embodiments, but should be given the broadest interpretation consistent with the description as a whole.

### DETAILED DESCRIPTION

I. Definitions

Unless otherwise indicated, the definitions and embodiments described in this and other sections are intended to be applicable to all embodiments and aspects of the present application herein described for which they are suitable as would be understood by a person skilled in the art.

In understanding the scope of the present application, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

The term “suitable” as used herein means that the selection of the particular compound or conditions would depend on the specific synthetic manipulation to be performed, and the identity of the molecule(s) to be transformed, but the selection would be well within the skill of a person trained in the art. All process/method steps described herein are to be conducted under conditions sufficient to provide the product shown. A person skilled in the art would understand that all reaction conditions, including, for example, reaction solvent, reaction time, reaction temperature, reaction pressure, reactant ratio and whether or not the reaction should be performed under an anhydrous or inert atmosphere, can be varied to optimize the yield of the desired product and it is within their skill to do so.

The expression “sufficient to provide the product shown” as used herein with reference to the reactions or method steps disclosed herein means that the reactions or method steps proceed to an extent that conversion of the starting material or substrate to product is maximized. Conversion may be maximized when greater than about 5, 10, 15, 20, 25, 30, 35, 40, 45, 50, 55, 60, 65, 70, 75, 80, 85, 90, 95 or 100% of the starting material or substrate is converted to product.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

As used in this application, the singular forms “a”, “an” and “the” include plural references unless the content clearly dictates otherwise. For example, an embodiment including “a poly(diorganosiloxane)” should be understood to present certain aspects with one poly(diorganosiloxane) or two or more additional poly(diorganosiloxane)s.

In embodiments comprising an “additional” or “second” component, such as an additional or second poly(diorganosiloxane), the second component as used herein is chemically different from the other components or first component. A “third” component is different from the other, first, and second components, and further enumerated or “additional” components are similarly different.

The term “alkyl” as used herein, whether it is used alone or as part of another group, means straight or branched chain, saturated alkyl groups. The number of carbon atoms that are possible in the referenced alkyl group are indicated by the numerical prefix “Cₙ₁₋ₙ₂”. For example, the term C₁₋₈alkyl means an alkyl group having 1, 2, 3, 4, 5, 6, 7 or 8 carbon atoms.

The term “alkenyl” as used herein, whether it is used alone or as part of another group, means straight or branched chain, unsaturated alkenyl groups. The number of carbon atoms that are possible in the referenced alkenyl group are indicated by the numerical prefix “Cₙ₁₋ₙ₂”. For example, the term C₂₋₈alkenyl means an alkenyl group having 2, 3, 4, 5, 6, 7 or 8 carbon atoms and at least one double bond, for example 1 to 3, 1 to 2 or 1 double bond.

The term “aryl” as used herein refers to cyclic groups that contain at least one aromatic ring. In an embodiment of the application, the aryl group contains from 6, 9 or 10 atoms, such as phenyl, naphthyl or indanyl. In another embodiment, the aryl group is a phenyl group.

The term “alkylene” as used herein, whether it is used alone or as part of another group, means straight or branched chain, saturated alkylene group; that is a saturated carbon chain that contains substituents on two of its ends. The number of carbon atoms that are possible in the referenced alkylene group are indicated by the numerical prefix “Cₙ₁₋ₙ₂”. For example, the term C₁₋₆ alkylene means an alkylene group having 1, 2, 3, 4, 5 or 6 carbon atoms.

The term “organofunctional group” as used herein refers to a functional grouping commonly used in organo-polymers, said group comprising carbon atoms, hydrogen atoms and/or at least one heteroatom selected from N, O and S. In an embodiment the organofunctional group is selected from amino (—NR′R″), amido (—C(O)NR′R″), epoxy

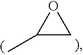

mercapto (—SR′), keto (—C(O)R′), cyanato (—CN) and isocyanato (—NCO), wherein R′ and R″ are independently selected from H, C₁₋₆ alkyl and C₆₋₁₀ aryl.

The term “halo” as used herein means “halogen” and includes fluorine, bromine, chlorine and iodine. In an embodiment, the halo is fluorine. When the halogen is a substituent group, it is referred to as a “halide”, for example “fluoride”.

The term “halo-substituted’ as used herein means that one or more, including all, of the available hydrogen atoms on a group are replaced with halo. Examples of a halo-substituted alkyl group are CCl₃, CF₃, CF₂CF₃, CH₂CF₃ and the like. Examples of halo-substituted aryl groups are C₆H₅Cl, C₆F₅, C₆H₄F and the like.

The term “available”, as in “available hydrogen atoms”, refers to atoms that would be known to a person skilled in the art to be capable of replacement by, for example, a fluorine atom using methods known in the art.

The term “organosilane” as used herein refers to an organic derivative of a silane containing at least one carbon-silicon bond.

The viscosity units expressed herein refer to the viscosity of a material at 25° C. as determined using a Brookfield viscometer according to ASTM D4287.

The term “superhydrophobic” as used herein refers to a material with a water droplet static contact angle above 150°. The term “static contact angle” as used herein refers to the contact angle of a static drop on a surface. For example, the contact angle of a water droplet on a surface is measured herein by contact angle goniometry. It will also be appreciated by a person skilled in the art that the STRI (Swedish Transmission Research Institute) has designed a visual guide for the classification of hydrophobicity of High Voltage Insulator surfaces. The guide classifies the insulator surface into six classes from completely hydrophobic (HC 1) to Completely Hydrophilic (HC 6). The STRI Guide further describes the criteria for their hydrophobicity classification by advancing and receding contact angles on an inclined surface. Table 1 describes the classification criteria based on receding contact angle. Contact angle goniometry can also be used, for example to measure advancing and receding contact angles. Advancing and receding contact angles are dynamic contact angles. The term “advancing contact angle” as used herein refers to the contact angle of the front side of a moving drop and the term “receding contact angle” as used herein refers to the contact angle of the rear side of a moving drop. The receding contact angle is smaller than the static contact angle whereas the advancing contact angle is greater than the static contact angle.

The term “thixotropic” as used herein refers to fluids that are highly viscous and become less viscous when stirred or shaken.

II. Compositions

The present application discloses superhydrophobic elastomeric silicone coatings which are useful, for example, for high voltage insulators, corrosion protection, anti-graffiti applications, waterproofing, drag reduction e.g. for waterborne vessels and/or to inhibit water from pooling on horizontal and near-horizontal surfaces. The combination of the low surface energy of the poly(diorganosiloxane) in the composition and microscopic level surface roughness contribute to the superhydrophobicity and the high contact angle of water droplets on the coating surface. While not wishing to be limited by theory, the nanoscale surface roughness traps air and forms a barrier between the coating surface and water. This trapped film of air not only causes the water droplets to form the highest contact angle but also prevents the contact of liquid water with the coating's surface when the coated substrate is fully immersed in water. The trapped air between the water and coating surface causes refraction of light and appears as a shiny mirror. The hydrophobicity of the coatings exceeds the visual standard HC 1 (Completely Hydrophobic) of the Swedish Transmission Research Institute (STRI) guide for the classification of hydrophobicity of High Voltage Insulator surfaces. Coatings of the present application possess excellent resistance to weathering and high temperature and also minimize or eliminate leakage of current caused, for example, by accumulation of pollutants and moisture on the insulator surface.

Accordingly, the present application includes a one-part room temperature vulcanizable (RTV) poly(diorganosiloxane) composition for a superhydrophobic elastomeric silicone coating, the composition comprising:

(a) about 10-60 wt % of a poly(diorganosiloxane) of Formula I:

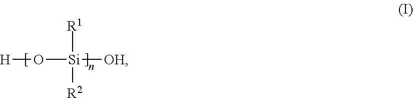

wherein
R¹ and R² are each independently C₁₋₈alkyl, C₂₋₈alkenyl or C₆₋₁₀aryl; and
n has an average value such that the viscosity of the poly(diorganosiloxane) of Formula I is from about 100-100,000 cP at 25° C.;

(b) about 0.5-25 wt % of an amorphous silica reinforcing filler;

(c) about 1-15 wt % of at least one cross-linking agent of Formula II:

(X)₄₋ₘ—Si—R³ₘ (II),

wherein
R³ is C₁₋₈alkyl, C₂₋₈alkenyl or C₆₋₁₀aryl;
m is 0, 1 or 2; and
X is a hydrolysable ketoximino-containing group of Formula III:

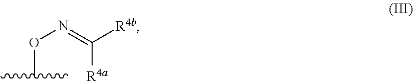

wherein R^{4a} and R^{4b} are each independently C₁₋₈alkyl, C₂₋₈salkenyl or C₆₋₁₀aryl; or
X is a hydrolysable group of Formula IV:

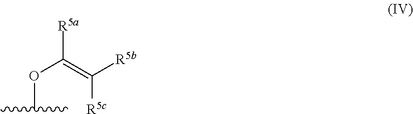

wherein R^{5a}, R^{5b} and R^{5c} are each independently H, C₁₋₈alkyl, C₂₋₈alkenyl or C₆₋₁₀aryl;

(d) about 0.2-5 wt % of an adhesion agent of Formula V:

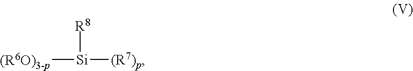

wherein
R⁶ and R⁷ are each independently C₁₋₈alkyl, C₂₋₈alkenyl or C₆₋₁₀aryl;
R⁸ is C₁₋₁₀alkyl, C₂₋₁₀alkenyl, C₁₋₆alkyleneNR⁹C₁₋₆alkyleneNR^{10a}R^{10b} or C₆₋₁₀aryl, optionally substituted with one or more organofunctional groups;
R⁹ is H or C₁₋₄alkyl;
R^{10a} and R^{10b} are each independently H or C₁₋₄alkyl; and
p is 0 or 1;

(e) about 0.01-2 wt % of an organometallic condensation catalyst, wherein the metal of the organometallic condensation catalyst is selected from tin, titanium, zirconium, boron, zinc, cobalt and bismuth; and

(f) about 5-35 wt % of an inorganic filler selected from natural diatomaceous earth, calcined diatomaceous earth, zeolite, pumice stone powder and mixtures thereof, dispersed in about 5-40 wt % of an organic solvent,

wherein each alkyl, alkylene, alkenyl and aryl group in the compounds of Formula I, II, III, IV and V is optionally halo-substituted.

In an embodiment, R¹ and R² are each independently C₁₋₈alkyl, C₂₋₈alkenyl or phenyl. In another embodiment, R¹ and R² are each independently C₁₋₆alkyl. In a further embodiment, R¹ and R² are each methyl.

In an embodiment, n has an average value such that the viscosity of the poly(diorganosiloxane) of Formula I is from about 750-25,000 cP at 25° C. In another embodiment, n has an average value such that the viscosity of the poly(diorganosiloxane) of Formula I is from about 1,000-10,000 cP at 25° C. In a further embodiment, n has an average value such that the viscosity of the poly(diorganosiloxane) of Formula I is about 5,000 cP at 25° C.

In another embodiment, R¹ and R² are each methyl and n has an average value such that the viscosity of the poly(diorganosiloxane) of Formula I is from about 1,000-10,000 cP at 25° C. In a further embodiment of the present application, R¹ and R² are each methyl and n has an average value such that the viscosity of the poly(diorganosiloxane) of Formula I is about 5,000 cP at 25° C.

In an embodiment, the poly(diorganosiloxane) of Formula I is present in an amount of about 30-45 wt %, about 30-35 wt % or about 35-45 wt %.

In an embodiment, the amorphous silica reinforcing filler has a surface area of about 50-400 g/m² and a particle size range of about 0.01-0.03 microns. In another embodiment, the amorphous silica reinforcing filler has a surface area of about 150-300 m²/g, about 100-150 m²/g or about 130 m²/g.

In an embodiment, the amorphous silica reinforcing filler is surface treated with an organosilane, hexamethyldisilazane or polydimethylsiloxane. In another embodiment, the amorphous silica reinforcing filler is surface treated with hexamethyldisilazane. In a further embodiment, the amorphous silica reinforcing filler is surface treated with polydimethylsiloxane. It is an embodiment that the amorphous silica reinforcing filler is surface treated with an organosilane. The organosilane is any suitable organosilane. Examples of suitable organosilanes include, for example, N-β-(aminoethyl)-γ-aminopropyltrimethoxysilane, γ-aminopropyltrimethoxysilane, γ-aminopropyltriethoxysilane, N-β-(aminoethyl)-γ-aminopropylmethyldimethoxysilane, γ-glycidoxypropyltrimethoxysilane, vinyltrimethoxysilane, γ-mercaptopropyltrimethoxysilane, methyltrimethoxysilane, n-octyltrimethoxysilane, γ-chloropropyltrimethoxysilane, γ-methacryloxypropyltrimethoxysilane, γ-isocyanatopropyltriethoxysilane, γ-isocyanatopropyltrimethoxysilane, (tridecafluoro-1,1,2,2-tetrahydrooctyl)triethoxysilane, 3-(heptafluoroisopropoxy)propyltrimethoxysilane, and mixtures thereof.

In an embodiment, the amorphous silica reinforcing filler is present in an amount of about 0.5-10 wt %, about 1-5 wt % or about 2 wt %.

In an embodiment, the cross-linking agent of Formula II is a cross-linking agent of Formula IIa:

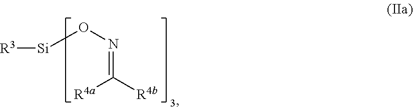

wherein

R³ is C₁₋₈alkyl, C₂₋₈alkenyl or C₆₋₁₀aryl; and

R^{4a} and R^{4b} are each independently C₁₋₈alkyl, C₂₋₈alkenyl or C₆₋₁₀aryl.

In another embodiment, R³ is C₁₋₈alkyl, C₂₋₈alkenyl or phenyl. In a further embodiment, R³ is C₁₋₆alkyl. It is an embodiment that R³ is methyl.

In another embodiment, R^{4a} and R^{4b} are each independently C₁₋₈alkyl, C₂₋₈alkenyl or phenyl. In a further embodiment, R^{4a} and R^{4b} are each independently C₁₋₆alkyl. It is an embodiment that R^{4a} is methyl and R^{4b} is ethyl.

In another embodiment, the cross-linking agent of Formula II is a cross-linking agent of Formula IIa, R³ and R^{4a} are methyl and R^{4b} is ethyl.

In an embodiment, the cross-linking agent of Formula II is a cross-linking agent of Formula IIb:

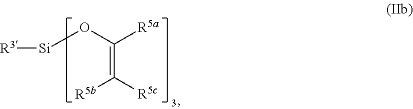

wherein

R^{3′} is C₁₋₈alkyl, C₂₋₈alkenyl or C₆₋₁₀aryl; and

R^{5a}, R^{5b} and R^{5c} are each independently H, C₁₋₈alkyl, C₂₋₈alkenyl or C₆₋₁₀aryl.

In another embodiment, R^{3′} is C₁₋₈alkyl, C₂₋₈alkenyl or phenyl. In a further embodiment, R^{3′} is C₂₋₆alkenyl. It is an embodiment that R^{3′} is vinyl.

In another embodiment of the present application, R^{5a}, R^{5b} and R^{5c} are each independently H, C₁₋₈alkyl, C₂₋₈alkenyl or phenyl. In a further embodiment, R^{5a}, R^{5b} and R^{5c} are each independently H or C₁₋₆alkyl. It is an embodiment that R^{5a} is methyl and R^{5b} and R^{5c} are both H.

In an embodiment, the cross-linking agent of Formula II is present in an amount of about 1-10 wt %, about 1-5 wt %, about 2 wt % or about 3 wt %.

In another embodiment of the present application, the adhesion agent of Formula V is an adhesion agent of Formula Va:

(R⁶O)₃—Si—R⁸ (Va),

wherein

R⁶ is C₁₋₈alkyl, C₂₋₈alkenyl or C₆₋₁₀aryl;

R⁸ is C₁₋₁₀alkyl, C₂₋₁₀alkenyl, C₁₋₆alkyleneNR⁹C₁₋₆alkyleneNR^{10a}R^{10b} or C₆₋₁₀aryl, optionally substituted with one or more groups selected from —NR′R″, —C(O)NR′R″),

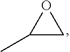

—SR′, —C(O)R′, —CN and —NCO, wherein R′ and R″ are independently selected from H, C₁₋₆alkyl and C₆₋₁₀aryl;

R⁹ is H or C₁₋₄alkyl; and

R^{10a} and R^{10b} are each independently H or C₁₋₄alkyl.

In an embodiment, R⁶ is C₁₋₈alkyl, C₂₋₈alkenyl or phenyl. In a further embodiment, R⁶ is C₁₋₆alkyl. It is an embodiment that R⁶ is methyl. In another embodiment, R⁸ is C₁₋₁₀alkyl, C₂₋₁₀alkenyl, C₁₋₆alkyleneNR⁹C₁₋₆alkyleneNR^{10a}R^{10b} or phenyl, optionally substituted with one or more groups selected from —NR′R″, —C(O)NR′R″),

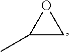

—SR′, —C(O)R′, —CN and —NCO, wherein R′ and R″ are independently selected from H, C₁₋₆alkyl and C₆₋₁₀aryl. In a further embodiment, R⁸ is C₁₋₆alkyleneNR⁹C₁₋₆alkyleneNR^{10a}R^{10b}. It is an embodiment that R⁸ is C₁₋₆alkyleneNHC₁₋₆alkyleneNH₂. In another embodiment of the present application, R⁸ is —(CH₂)₃—NH—(CH₂)₂NH₂.

In an embodiment, R⁹ is H. In another embodiment R^{10a} and R^{10b} are both H. In a further embodiment, R⁹, R^{10a} and R^{10b} are all H.

In another embodiment, the adhesion agent of Formula V is an adhesion agent of Formula Va, R⁶ is methyl and R⁸ is —(CH₂)₃—NH—(CH₂)₂NH₂.

In an embodiment, the adhesion agent is present in an amount of about 0.5-4 wt %, about 0.5-2 wt % or about 1 wt %.

In an embodiment, the organometallic condensation catalyst is an organotin condensation catalyst. In another embodiment, the organometallic condensation catalyst is selected from dibutyltin dilaurate, dioctyltin di-(2-ethylhexanoate), dioctyltin dilaurate, lauryl stannoxane, dibutyltin diketonoate, dibutyltin diacetate, dibutyltin bis-(isooctyl maleate), dioctyltin dineodecanoate, dimethyltin dineodecanoate and mixtures thereof. In a further embodiment, the organometallic condensation catalyst is dibutyltin dilaurate.

In an embodiment, the organometallic condensation catalyst is present in an amount of about 0.05-1 wt %, about 0.05-0.5 wt % or about 0.1 wt %.

In another embodiment, the composition further comprises an extending filler. In an embodiment, the composition comprises about 5-60 wt % of an extending filler selected from quartz silica, alumina trihydrate, calcium carbonate, barium sulphate, ceramic microspheres, hollow glass spheres, magnesium hydroxide, fly ash, nepheline syenite, melamine powder, titanium dioxide, zinc oxide, zinc chromate, zirconium oxide and mixtures thereof. The selection of a suitable extending filler will depend, for example, on the environment in which the coating is used and the selection of a suitable extending filler can be made by a person skilled in the art.

In an embodiment, the extending filler comprises, consists essentially of or consists of alumina trihydrate. In another embodiment, the extending filler has a median particle size of about 13 μm; comprises Al₂O₃ in an amount of about 65.1 wt %; H₂O in an amount of about 34.5 wt %; Na₂O in an amount of about 0.3 wt %; CaO in an amount of about 0.02 wt %; and SiO₂ in an amount of about 0.01 wt %, based on the total weight of the extending filler; and has a specific gravity of about 2.42.

In an embodiment, the extending filler comprises, consists essentially of or consists of quartz powder. In another embodiment, the extending filler is quartz powder having a median particle size of 10 μm.

In an embodiment, the extending filler is present in an amount of about 10-45 wt %, about 20-40 wt % or about 30 wt %.

In an embodiment, the inorganic filler is natural diatomaceous earth. In another embodiment of the present application, the inorganic filler comprises natural diatomaceous earth which has been heated to a temperature of about 300-600° C. or about 500-700° C. under conditions suitable to remove organic compounds from the pores and voids of the porous structure of the diatomaceous earth.

In another embodiment, the inorganic filler is calcined diatomaceous earth. It was found that smaller particles gave higher values for contact angle. For example, using calcined diatomaceous earth having a median particle size of 1.9 microns gave a superhydrophobic elastomeric silicone coating having a static contact angle of about 160°. Accordingly, in a further embodiment, the inorganic filler is calcined diatomaceous earth having a median particle size of about 1-6 microns, about 1.5 to about 2.5 microns or about 1.9 microns.

Typically, the presence of a higher amount of inorganic filler on the surface of a superhydrophobic elastomeric silicone coating prepared from the composition gives a texture or microscopic surface roughness that is useful for obtaining a higher contact angle. While not wishing to be limited by theory, pre-wetting (surface treating) of the inorganic filler prior to dispersion in the organic solvent can, for example, help to bloom the inorganic filler to the surface of a superhydrophobic elastomeric silicone coating prepared from the composition thereby giving it a microscopic surface texture. Further, the microscopic level surface roughness can trap air that prevents contact of a water droplet with the surface and can give a higher contact angle. Accordingly, in another embodiment, the inorganic filler is surface treated with an organosilane or a hydrocarbon prior to dispersion in the organic solvent. In another embodiment, the hydrocarbon comprises, consists essentially of or consists of stearic acid.

The inorganic filler is present in the composition in an amount below the CPVC (Critical Pigment Volume Concentration). The CPVC for the compositions of the present application is about 35 wt %. In an embodiment, the inorganic filler is present in an amount of about 5-20 wt % or about 10-15 wt %.

In another embodiment, the inorganic filler is dispersed in about 10-30 wt % of organic solvent or about 20 wt % of organic solvent.

The organic solvent is any suitable organic solvent. In an embodiment of the present application, the organic solvent comprises, consists essentially of or consists of petroleum naptha, xylene, toluene or a halogenated hydrocarbon. In an embodiment, the halogenated hydrocarbon is parachlorobenzotrifluoride (PCBTF) or perchloroethylene.

In an embodiment, the composition further comprises a pigment. In another embodiment of the present application, the pigment is present in an amount of about 0.1-10 wt %, about 1-5 wt % or about 3 wt %.

III. Methods

The present application also includes a method of coating a high voltage insulator with a superhydrophobic elastomeric silicone coating, the method comprising:

coating a high voltage insulator with a one-part room temperature vulcanizable (RTV) poly(diorganosiloxane) composition of the present application; and

allowing the composition to cure under conditions to obtain the superhydrophobic elastomeric silicone coating.

While not wishing to be limited by theory, the water of crystallization of alumina trihydrate can provide cooling in case of a high voltage flash that could otherwise burn the coating due to the release of heat therefore it is useful to use a one-part room temperature vulcanizable (RTV) poly(diorganosiloxane) composition of the present application which includes alumina trihydrate in the methods of coating a high voltage insulator of the present application.

Accordingly, in an embodiment of the present application, the one-part room temperature vulcanizable (RTV) poly(diorganosiloxane) composition of the present application used in the methods of coating a high voltage insulator of the present application comprises about 5-60 wt % of an extending filler wherein the extending filler is alumina trihydrate. In another embodiment, the extending filler has a median particle size of about 13 μm; comprises Al₂O₃ in an amount of about 65.1 wt %; H₂O in an amount of about 34.5 wt %; Na₂O in an amount of about 0.3 wt %; CaO in an amount of about 0.02 wt %; and SiO₂ in an amount of about 0.01 wt %, based on the total weight of the extending filler; and has a specific gravity of about 2.42. In a further embodiment, the extending filler is present in an amount of about 10-45 wt %, about 20-40 wt % or about 30 wt %.

In another embodiment, the substrate comprises glass, porcelain or a composite material. In another embodiment, the composite material comprises ethylene propylene diene terpolymer (EPDM), epoxy and silicone rubber.

The present application further includes a method of protecting a substrate, the method comprising:

coating the substrate with a one-part room temperature vulcanizable (RTV) poly(diorganosiloxane) composition of the present application; and

allowing the composition to cure under conditions to obtain a superhydrophobic elastomeric silicone coating.

The present application also includes a method of waterproofing a substrate, for reducing drag on a substrate and/or for inhibiting water from pooling on a horizontal or near-horizontal substrate, the method comprising:

coating the substrate with a one-part room temperature vulcanizable (RTV) poly(diorganosiloxane) composition of the present application; and

allowing the composition to cure under conditions to obtain a superhydrophobic elastomeric silicone coating.

The present application also includes a method of protecting a substrate, of waterproofing a substrate, for reducing drag on a substrate and/or for inhibiting water from pooling on a horizontal or near-horizontal substrate, the method comprising:

coating the substrate with a one-part room temperature vulcanizable (RTV) poly(diorganosiloxane) composition of the present application; and

allowing the composition to cure under conditions to obtain a superhydrophobic elastomeric silicone coating.

In some embodiments wherein the method is for reducing drag on a substrate, the substrate comprises a waterborne vessel.

In some embodiments, using a one-part room temperature vulcanizable (RTV) poly(diorganosiloxane) composition of the present application which includes quartz powder in the methods of the present application, increases the anti-corrosion properties of the coating prepared therefrom (e.g. in some embodiments, the coating forms a barrier between the substrate and a corrosive environment so as to protect the substrate from corrosion) and/or increases the coating's physical properties that are useful for protection from other environmental effects such as weathering or thermal and mechanical stress.

Accordingly, in an embodiment, the one-part room temperature vulcanizable (RTV) poly(diorganosiloxane) composition of the present application used in the methods of the present application comprises about 5-60 wt % of an extending filler wherein the extending filler is quartz powder. In another embodiment, the extending filler is quartz powder having a median particle size of 10 μm. In a further embodiment, the extending filler is present in an amount of about 10-45 wt %, about 20-40 wt % or about 30 wt %.

Prior to the coating, in some embodiments, the composition is prepared by mixing the components of the composition. It will be appreciated by a person skilled in the art that the catalysts, cross-linking agents and the adhesion agents are moisture sensitive therefore the composition is typically maintained substantially free of moisture until it is desired to cure the composition.

In an embodiment, the composition is prepared by a method comprising:
(a) combining the poly(diorganosiloxane) of Formula I, the amorphous silica reinforcing filler and the extending filler (if present) using suitable means such as a planetary mixer or high shear mixer;
(b) adding the at least one cross-linking agent of Formula II then the adhesion agent of Formula V to the mixture obtained from (a) and combining under conditions to form a stable, homogeneous mixture;
(c) in a separate vessel, dispersing the inorganic filler in a suitable amount of the organic solvent to obtain a paste; and
(d) adding the paste obtained from (c) to the mixture obtained from (b) and combining under conditions to obtain a thixotropic liquid.

In an embodiment, the prepared composition is dispensed into vessels which can be sealed and optionally stored prior to use.

It will be appreciated by a person skilled in the art that the substrate can be coated by any suitable means for coating a substrate with a one-part room temperature vulcanizable (RTV) poly(diorganosiloxane) composition and the selection of a suitable means for a particular substrate and/or application can be made by a person skilled in the art. In an embodiment of the present application, the composition is coated on the substrate via spraying, brushing, rolling, trowelling, calendaring, a squeegee and/or an air knife. In an embodiment, the composition is coated on a substrate via spraying.

In an embodiment, the conditions to obtain the superhydrophobic elastomeric silicone coating comprise subjecting the composition to an ambient atmosphere for a time and temperature until the curing of the composition has proceeded to a sufficient extent, for example a time of about 40 minutes to about 7 days or about 0.5 hours to about 2 hours at a temperature of about −20° C. to about 75° C. or about −13° C. to about 32° C. In an embodiment, the relative humidity is from about 45% to about 70% or about 40% to about 60%.

In an embodiment, the superhydrophobic elastomeric silicone coating has a thickness of about 250-400 microns.

In an embodiment of the method of coating a high voltage insulator of the present application, the superhydrophobic elastomeric silicone coating is classified as HC 1 using the Swedish Transmission Research Institute guide for classification of hydrophobicity of high voltage insulator surfaces.

In an embodiment of the method of protecting a substrate, the superhydrophobic elastomeric coating is for protecting the substrate from environmental effects (such as corrosion) and/or graffiti. In an embodiment of the method of protecting a substrate, of waterproofing a substrate, for reducing drag on a substrate and/or for inhibiting water from pooling on a horizontal or near-horizontal substrate, the protecting comprises protecting the substrate from environmental effects and/or graffiti.

In another embodiment, the substrate comprises metal (e.g. a corrosive metal), concrete (bare or painted), wood, natural stone (e.g. marble or granite) or combinations thereof.

IV. Coated High Voltage Insulators

The present application further includes a coated high voltage insulator comprising a superhydrophobic elastomeric silicone coating obtained according to a method of coating a high voltage insulator of the present application and a coated high voltage insulator comprising a superhydrophobic elastomeric silicone coating prepared from a one-part room temperature vulcanizable (RTV) poly(diorganosiloxane) composition of the present application.

In an embodiment, the superhydrophobic elastomeric silicone coating has a thickness of about 250-400 microns.

In another embodiment, the superhydrophobic elastomeric silicone coating is classified as HC 1 using the Swedish Transmission Research Institute guide for classification of hydrophobicity of high voltage insulator surfaces.

In another embodiment, the high voltage insulator comprises glass, porcelain or a composite material. In another embodiment, the composite material comprises ethylene propylene diene terpolymer (EPDM), epoxy and silicone rubber.

The following non-limiting examples are illustrative of the present application:

### EXAMPLES

Determination of Static, Advancing and Receding Contact Angles

The samples were analysed by contact angle goniometry using a Ramo-Hart Model 100 goniometer equipped with a micro-syringe system to allow the determination of static, advancing and receding contact angles.

The volume of the droplet for the determination of the static angle was maintained between 10 and 12 microlitres.

The advancing and receding contact angles were measured using the principle of the volume changing method. A small droplet was placed on the surface and the static contact angle measured. The syringe needle was then brought into contact with the droplet and the volume of the droplet was gradually increased while recording the angle of the advancing front with the surface. This gave the advancing contact angle. The receding angle was measured in a similar manner while reducing the volume of the droplet.

The analyses were performed using water as the probe liquid. Three or four measurements were made on each sample, allowing an average and standard deviation for each value to be calculated.

A number of assumptions are typically made in determining contact angles. These assumptions include the following: (1) the solid surface is rigid, immobile and non-deformable; (2) the surface is highly smooth, uniform and homogeneous; and (3) the solid surface does not interact in any way with the probe liquid (no swelling, dissolution or extraction).

The following are the results of a contact angle measurement applied to an exemplary coating having a 250 micron dry film thickness:

Static Contact Angle: 160.7°±3.8°

Advancing Contact Angle: 166.7°±4.2°

Receding Contact Angle: 144.7°±4.0°.

### Example 1

### Preparation of an Exemplary Superhydrophobic Elastomeric Silicone Coating for a High Voltage Insulator

40 parts by weight of polydimethylsiloxane fluid having a viscosity of 5,000 centipoise and 2 parts by weight of surface treated amorphous silica having a surface treatment with hexamethyldisilazane and a surface area of about 130 m²/g were mixed. Then 2 parts by weight of methyl tris-(methyl ethyl ketoxime) silane and 1 part by weight of N-(2-aminoethyl-3-aminopropyl) trimethoxysilane were added and mixed under a nitrogen atmosphere. Then 30 parts by weight of alumina trihydrate powder of median particle size 13 micron, was added and mixed. To prepare a coating with a desired colour 3 parts by weight of pigment paste was also added and mixed to a uniform consistency. The pigment paste was prepared by mixing 50 parts by weight of pigment powder into polydimethylsiloxane fluid. Then 0.1 parts by weight of dibutyltin dilaurate was added and mixed thoroughly. In another container, 10 parts by weight of calcined diatomaceous earth of median particle size 5.5 micron was mixed with 20 parts by weight of petroleum naphtha solvent. The diatomaceous earth dispersion was then added to the coating formulation and mixed until a uniform mixture was achieved. The coating composition was then applied to a substrate to achieve a uniform thickness between 250 to 400 micron dry film thickness and cured at room condition. The cured coating showed excellent electrical properties and superhydrophobicity.

### Example 2

### Preparation of an Exemplary Superhydrophobic Elastomeric Silicone Coating for Protecting a Substrate from Environmental Effects

33 parts by weight of polydimethylsiloxane fluid having a viscosity of 5,000 centipoise and 2 parts by weight of surface treated amorphous silica having a surface treatment with polydimethylsiloxane and a surface area of about 130 m²/g were mixed. Then 3 parts by weight of methyl tris-(methyl ethyl ketoxime) silane and 1 part by weight of N-(2-aminoethyl-3-aminopropyl) trimethoxy silane were added and mixed under a nitrogen atmosphere. Then 30 parts by weight of quartz powder of median particle size 10 micron, was added and mixed. To prepare a coating with a desired colour, 3 parts by weight of pigment paste was also added and mixed to a uniform consistency. The pigment paste was prepared by mixing 50 parts by weight of pigment powder into polydimethylsiloxane fluid. Then 0.1 parts by weight of dibutyltin dilaurate was added and mixed thoroughly. In another container, 10 parts by weight of calcined diatomaceous earth of median particle size 5.5 micron was mixed with 20 parts by weight of petroleum naphtha solvent. The diatomaceous earth dispersion was then added to the coating formulation and mixed until a uniform mixture was achieved. The coating composition was then applied to a substrate to achieve a uniform thickness between 250 to 400 micron dry film thickness and cured at room condition. The cured coating showed excellent superhydrophobicity and anti-corrosion properties.

### Discussion

The low surface energy and superhydrophobic properties of the elastomeric silicone coatings of the present studies makes them useful for improving the performance of high voltage insulators and/or for protection of structures from environmental effects, such as corrosion. The low surface energy of the coating also prevents adhesion of other paints and inks on its surface and thus makes its surface an anti-graffiti or graffiti resistant surface. The superhydrophobic elastomeric coatings of the present studies may further be useful for waterproofing, for drag reduction in waterborne vessels and/or to inhibit water from pooling on horizontal and near-horizontal surfaces.

The elastomeric silicone coatings for high voltage insulators of the present studies improve and prolong the performance of the high voltage insulator by virtue of their superhydrophobic and dielectric properties. The superhydrophobic properties of the elastomeric silicone coatings cause the water to break into beads thus preventing a continuous stream that could form a conductive path. The conductive path could, for example, cause loss of energy by leakage of current. The degree of hydrophobicity of a hydrophobic surface can be measured by the contact angle of the water droplet on its surface. A high contact angle means less contact of the water droplet with the surface, which helps facilitate the rolling of the water droplet from the surface.

The superhydrophobic property of the coatings of the present studies also contributes to corrosion protection by making the surface repellant to liquid water. A lack of hydrophobicity can, for example, result in accumulation of liquid water on a coating's surface that eventually penetrates through the coating to reach the substrate. Liquid water on a substrate in the presence of a soluble salt forms a corrosion cell that electrochemically oxidizes the metal and causes corrosion.

The superhydrophobic coatings on the surface of substrates or high voltage insulators also lower the surface energy by repelling the water. The coatings of the present studies may also, for example, display self-cleaning properties to keep the coated surface clean and free from moisture.

While the present application has been described with reference to examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

TABLE 1

| HC | Description |
|---|---|
| 1 | Only discrete droplets are formed. |
| | θᵣ ≅ 80° or larger for the majority of droplets. |
| 2 | Only discrete droplets are formed. |
| | 50° < θᵣ < 80° for the majority of droplets. |
| 3 | Only discrete droplets are formed. |
| | 20° < θᵣ < 50° for the majority of droplets. |
| | Usually they are no longer circular. |
| 4 | Both discrete droplets and wetted traces from the water runnels are |
| | observed (i.e. θᵣ = 0°). Completely wetted areas < 2 cm². |
| | Together they cover < 90% of the tested area. |
| 5 | Some completely wetted areas > 2 cm², which cover < 90% of the |
| | tested area. |
| 6 | Wetted areas cover > 90%, i.e. small unwetted areas (spots/traces) |
| | are still observed. |

1. A one-part room temperature vulcanizable (RTV) poly(diorganosiloxane) composition for a superhydrophobic elastomeric silicone coating, the composition comprising:
(a) about 10-60 wt % of a poly(diorganosiloxane) of Formula I: 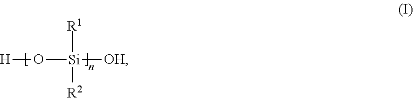
wherein
R¹ and R² are each independently C₁₋₈alkyl, C₂₋₈alkenyl or C₆₋₁₀aryl; and
n has an average value such that the viscosity of the poly(diorganosiloxane) of Formula I is from about 100-100,000 cP at 25° C.;
(b) about 0.5-25 wt % of an amorphous silica reinforcing filler;
(c) about 1-15 wt % of at least one cross-linking agent of Formula II:
(X)₄₋ₘ—Si—R³ₘ (II),
wherein
R³ is C₁₋₈alkyl, C₂₋₈alkenyl or C₆₋₁₀aryl;
m is 0, 1 or 2; and
X is a hydrolysable ketoximino-containing group of Formula III: 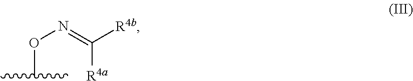
wherein R^{4a} and R^{4b} are each independently C₁₋₈alkyl, C₂₋₈alkenyl or C₆₋₁₀aryl; or
X is a hydrolysable group of Formula IV: 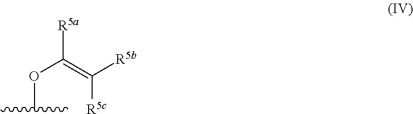
wherein R^{5a}, R^{5b} and R^{5c} are each independently H, C₁₋₈alkyl, C₂₋₈alkenyl or C₆₋₁₀aryl;
(d) about 0.2-5 wt % of an adhesion agent of Formula V: 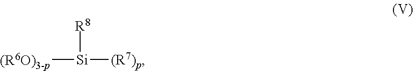
wherein
R⁶ and R⁷ are each independently C₁₋₈alkyl, C₂₋₈alkenyl or C₆₋₁₀aryl;
Fe is C₁₋₁₀alkyl, C₂₋₁₀alkenyl, C₁₋₆alkyleneNR⁹C₁₋₆alkyleneNR^{10a}R^{10b} or C₆₋₁₀aryl, optionally substituted with one or more organofunctional groups;
R⁹ is H or C₁₋₄alkyl;
R^{10a} and R^{10b} are each independently H or C₁₋₄alkyl; and
p is 0 or 1;
(e) about 0.01-2 wt % of an organometallic condensation catalyst, wherein the metal of the organometallic condensation catalyst is selected from tin, titanium, zirconium, boron, zinc, cobalt and bismuth; and
(f) about 5-35 wt % of an inorganic filler selected from natural diatomaceous earth, calcined diatomaceous earth, zeolite, pumice stone powder and mixtures thereof, dispersed in about 5-40 wt % of an organic solvent,
wherein each alkyl, alkylene, alkenyl and aryl group in the compounds of Formula I, II, III, IV and V is optionally halo-substituted.

2. The composition of claim 1, wherein R¹ and R² are each methyl and n has an average value such that the viscosity of the poly(diorganosiloxane) of Formula I is from about 1,000-10,000 cP at 25° C.

3. The composition of claim 1, wherein the poly(diorganosiloxane) of Formula I is present in an amount of about 30-45 wt %; the amorphous silica reinforcing filler is present in an amount of about 1-5 wt %; the cross-linking agent of Formula II is present in an amount of about 1-5 wt %; the adhesion agent of Formula V is present in an amount of about 0.5-2 wt %; the organometallic condensation catalyst is present in an amount of about 0.05-0.5 wt %; the inorganic filler is present in an amount of about 5-20 wt %; and the inorganic filler is dispersed in about 10-30 wt % of organic solvent.

4. The composition of claim 1, wherein the amorphous silica reinforcing filler has a surface area of about 150-300 g/m²; a particle size range of about 0.01-0.03 microns; and the amorphous silica reinforcing filler is surface treated with an organosilane, hexamethyldisilazane or polydimethylsiloxane.

5. The composition of claim 1, wherein the cross-linking agent is a cross-linking agent of Formula IIa: 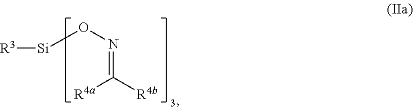
wherein R³ and R^{4a} are methyl and R^{4b} is ethyl.

6. The composition of claim 1, wherein the adhesion agent is an adhesion agent of Formula Va:
(R⁶O)₃—Si—R⁸ (Va),
wherein R⁶ is methyl and R⁸ is —(CH₂)₃—NH—(CH₂)₂NH₂.

7. The composition of claim 1, wherein the organometallic condensation catalyst is dibutyltin dilaurate.

8. The composition of claim 1, further comprising about 5-60 wt % of an extending filler selected from quartz silica, alumina trihydrate, calcium carbonate, barium sulphate, ceramic microspheres, hollow glass spheres, magnesium hydroxide, fly ash, nepheline syenite, melamine powder, titanium dioxide, zinc oxide, zinc chromate, zirconium oxide and mixtures thereof.

9. The composition of claim 8, wherein the extending filler has a median particle size of about 13 μm; comprises Al₂O₃ in an amount of about 65.1 wt %; H₂O in an amount of about 34.5 wt %; Na₂O in an amount of about 0.3 wt %; CaO in an amount of about 0.02 wt %; and SiO₂ in an amount of about 0.01 wt %, based on the total weight of the extending filler; and has a specific gravity of about 2.42; and wherein the extending filler is present in an amount of about 20-40 wt %.

10. The composition of claim 8, wherein the extending filler is quartz powder having a median particle size of 10 μm; and wherein the extending filler is present in an amount of about 20-40 wt %.

11. The composition of claim 1, wherein the organic solvent comprises petroleum naptha, xylene, toluene or a halogenated hydrocarbon.

12. The composition of claim 1, wherein the inorganic filler is surface treated with an organosilane or a hydrocarbon prior to dispersion in the organic solvent.

13. The composition of claim 1, wherein the inorganic filler comprises natural diatomaceous earth which has been heated to a temperature of about 300-600° C. under conditions suitable to remove organic compounds from the pores and voids of the porous structure of the diatomaceous earth; or the inorganic filler is calcined diatomaceous earth having a median particle size of about 1-6 microns.

14. The composition of claim 1, further comprising about 0.1-10 wt % of a pigment.

15. A method of coating a high voltage insulator with a superhydrophobic elastomeric silicone coating, the method comprising:
coating a high voltage insulator with a composition according to claim 9; and
allowing the composition to cure under conditions to obtain the superhydrophobic elastomeric silicone coating.

16. The method of claim 15, wherein the high voltage insulator comprises glass, porcelain or a composite material.

17. A method of protecting a substrate, of waterproofing a substrate, for reducing drag on a substrate and/or for inhibiting water from pooling on a horizontal or near-horizontal substrate, the method comprising:
coating the substrate with a composition according to claim 1; and
allowing the composition to cure under conditions to obtain a superhydrophobic elastomeric silicone coating.

18. The method of claim 17, wherein the protecting the substrate comprises protecting the substrate from environmental effects and/or graffiti.

19. The method of claim 17, wherein the superhydrophobic elastomeric silicone coating has a thickness of about 250-400 microns.

20. The method of claim 15, wherein the superhydrophobic elastomeric silicone coating is classified as HC 1 using the Swedish Transmission Research Institute guide for classification of hydrophobicity of high voltage insulator surfaces.
